(19) United States
(12) Patent Application Publication
(10) Pub. No.: US 2023/0419614 A1
(43) Pub. Date: Dec. 28, 2023

(54) SYSTEM AND METHOD FOR DELIVERING INTERACTIVE LABORATORY EXPERIMENTS REAL-TIME IN SIMULATED ENVIRONMENTS

(71) Applicant: City University of Hong Kong, Hong Kong (CN)

(72) Inventors: Yun Wah LAM, Hong Kong (CN); Kwan Yin YU, Hong Kong (CN)

(21) Appl. No.: 17/809,041

(22) Filed: Jun. 27, 2022

(51) Int. Cl. G06T 19/00; H04L 65/613; G06T 7/246; H04L 65/65

(52) U.S. Cl. CPC G06T 19/006; H04L 65/613; G06T 7/246; H04L 65/65; B33Y 80/00

(57) ABSTRACT

The present disclosure provides an integrated platform allowing multiple users to share and exchange motion, position, image and other data of a set of replicas or phantoms mimicking genuine objects used in real life scientific laboratory within a common virtual space resembling a scientific laboratory, where the motion and position data are tracked real-time by multiple sensors embedded into the phantoms and transformed using a physically accurate rendering approach into dynamic images of their corresponding genuine objects to be displayed in an augmented reality projection, so that the users can remotely connect to the platform via a portable device to learn and practice skills of handling laboratory apparatuses from experiencing in the common virtual space with one or more of the phantoms.

### TECHNICAL FIELD

The present invention relates to a system and method for delivering interactive laboratory experiments real-time in simulated environments. In particular, the present invention provides a set of purpose-specific apparatuses having multiple motion- and position-sensors for providing spatial and kinetic information for a platform incorporated with a program that can process and manipulate the information in order to provide a realistic tactile and haptic experience for user of the platform in a simulated augmented reality environment remotely.

### BACKGROUND

Online teaching is increasingly becoming an indispensable part of education in past two decades. The advent and the continued popularity of Massive Open Online Courses (MOOC) has transformed education beyond the restraints of traditional classroom settings. Natural disasters, such as the Covid-19 pandemic in early 21^{st} century, can limit the access of students and teachers to schools on a global scale, leaving online teaching the only viable medium of education over a sustained period of time. Online teaching is particularly crucial for education in developing countries where the access to schools, libraries and laboratories is scarce. In many cases, online teaching is beginning to rival traditional classroom teaching in effectiveness. It is foreseeable that certain aspects of online teaching will continue to complement, even pose to replace, traditional learning experiences.

Despite the obvious benefits of online teaching, not all aspects of education can be conducted virtually and remotely. For instance, most science courses contain a substantial component of laboratory classes, in which students learn technical skills for collecting and analyzing data. Educators worldwide have developed creative ideas and technologies for teaching lab works online. This typically includes watching videos that depict experimental procedures, supported by online discussions on experimental design and data analysis. The demand for lab videos is so great that even a commercial publisher (Journal of Visualised Experiments) has recently produced more than 60 videos for chemistry experiments at university level. However, initial surveys have indicated that the feedback from science students towards this format of learning has been negative. Meanwhile, some students are guided remotely by their instructors to conduct unsupervised experiments at or in the neighborhood of their own homes. But these practices are limited to “kitchen science” and cannot be applied to lab works that involve expensive equipment and toxic reagents. To overcome this limitation, some educators have created “gamified” versions of research laboratories to give students a simulated experience in performing experiments. However, concrete proofs of the benefits of lab simulations on learning performance still remains to be seen.

A recent extensive survey on the undergraduate students in a chemistry department of a North American university has indicated that the learning experience most students missed during the Covid19 lockdown in 2020-2021 is “hands-on experience”. Laboratory classes are quintessentially physical experiences, involving the learning of haptic and manual skills that can seldom be reproduced in lab simulations. For example, in acid-base titration, one of the most fundamental volumetric analytical techniques in chemistry, the student needs to set up a burette over a conical flask. A precise volume of the analyte needs to be pipetted into the conical flask, while the volume of the titrant solution in the burette is accurately recorded. By carefully controlling the stopcock of the burette, the student needs to add just enough titrant into the conical flask to change the color of the indicator in the analyte, while constantly swirling the flask for effective mixing. Moreover, the burette has to be set up perfectly vertical to ensure the accurate reading of the initial and final titrant volume. Hence, the successful completion of this experiment requires not only the theoretical understanding of the procedure but also a dexterous skill and eye-hand coordination that cannot be replicated in the absence of the apparatus. In most augmented or virtual reality simulations of titration, the control of the burette stopcock is usually replaced by a click of a button or by an empty hand gesture, thus depriving the learners of the essential haptic experience. Moreover, most videoed demonstrations and lab simulations only show the procedure performed correctly and under perfect conditions. Learners are not able to “learn by mistakes”, a cornerstone of science education. The proficiency of the type of haptic and tactile abilities involved in titration is required in almost all lab works in chemistry, and the acquisition of these skills represents a profound degree of challenge in the age of virtual learning.

A need therefore exists for an interactive learning platform for learners to gain tactile and haptic experience and practice dexterous skills involved in a real laboratory experiment, whilst an instructor can review and evaluate individual performance and skills from real-time data received by the platform, in order to address the inadequacies and drawbacks of the existing remote or virtual learning platform.

### SUMMARY OF THE INVENTION

Accordingly, a first aspect of the present invention provides a platform integrating both hardware and software for delivering interactive laboratory experiments real-time in simulated environments. In particular, the present invention provides a platform integrating a set of replicas of laboratory apparatuses (or phantoms) configured to have multiple motion- and position-sensors and electronics for detecting and providing spatial and/or kinetic information of the corresponding apparatus(es) (or phantoms) for a data processing unit (or a network) of the platform to process and translate the data derived therefrom into signals to be output by one or more augmented reality devices. Users of the platform, including learners and instructor, are able to obtain the output signals from the corresponding augmented reality device(s), react to a particular output signal, act on a subsequent step following a particular output signal, and repeat, modify, or terminate a session of an interactive laboratory experiment, etc.

The platform in the first aspect includes one or more phantoms incorporated with at least an assembly of motion- and position-sensors, and at least one marker for a corresponding imaging module to capture.

In certain embodiments, the assembly of motion- and position-sensors is selected from an inertia measuring unit (IMU).

In other embodiments, the assembly of motion- and position-sensors may include one or more wireless monitoring sensors including, but not limited to, a dual phase resistive position sensor.

In certain embodiments, the at least one marker is selected from an OpenCV ArUco synthetic marker.

In other embodiments, the at least one marker may include one or more computer-vision markers.

In certain embodiments, the assembly of motion- and position-sensors is embedded into each of the phantoms.

In certain embodiments, the at least one marker is affixed on a surface of each of the phantoms in a way to be visualized and captured by the imaging module.

In certain embodiments, the assembly of motion- and position-sensors is configured to passively track spatial position, acceleration (linear or angular), and velocity (linear or angular) of the corresponding phantom.

In certain embodiments, the at least one marker is configured to be captured and identified by the imaging module in order for the spatial position, acceleration (linear or angular), and velocity (linear or angular) of the corresponding phantom to be actively tracked.

In certain embodiments, the imaging module, the data processing unit and the augmented reality device may be from separate devices or from the same device.

In certain embodiments, the augmented reality device is a portable device with a simulation module for realizing augmented reality and an imaging module for capturing the at least one marker on a surface of the corresponding phantom and determining identity thereof.

In certain embodiments, the augmented reality device is configured to provide timestamp for each of the images captured by the imaging module in order to facilitate sequencing of the captured images and synchronization with the corresponding spatial and kinetic information obtained by the assembly of motion- and position-sensors.

In certain embodiments, the one or more phantoms are fabricated by 3-D printing.

In certain embodiments, the one or more phantoms are configured to have substantially similar shape, size, weight and surface roughness with respect to their corresponding genuine objects.

A second aspect of the present invention provides a method for using the platform described herein to deliver an interactive laboratory experiment lecture real-time in simulated environments. The method includes:
one or more users of the platform connecting one or more of his or her portable devices remotely to a network at where the laboratory experiment lecture is to be delivered;
a first user or any subsequent users to the first user creating or selecting a virtual laboratory setting and corresponding protocols for the laboratory experiment lecture to be delivered via a user interface of a program implementable on his or her corresponding portable device;
displaying the virtual laboratory setting with or without any virtual laboratory apparatuses on a display panel of one or more of the portable devices, upon the corresponding users' preference to participate as a learner or instructor of the lecture;
each of the first and the subsequent users sending a request for spatial, kinetic and/or other information of another user's phantom or transmitting spatial, kinetic, and/or other information of his or her phantom, or both simultaneously, from his or her portable device to the network;
receiving the spatial, kinetic and/or other information of another user's phantom simultaneously from the network and transforming corresponding spatial position and motion data into a series of dynamic images to be integrated into the virtual laboratory setting and displayed as an augmented reality images on the display screen of the corresponding portable device;
any of the first and subsequent users of the platform continuously sending, transmitting, and receiving the spatial, kinetic and/or other information of another user's phantoms via the network and the corresponding augmented reality images being synchronized with the augmented reality images of his or her phantom in the same virtual laboratory setting to be displayed on the display screen of the corresponding portable device over a course of the laboratory experiment lecture until a command or instruction to pause, exit or cease the lecture by any of the users according to his or her preference.

In certain embodiments, the transformation of spatial and kinetic information into the dynamic images to be integrated into the virtual laboratory setting and displayed as an augmented reality images based on a physically-based rendering approach as physically accurate renderings.

In certain embodiments, the physically accurate renderings are incorporated into augmented reality projection to be displayed on the display screen of the corresponding portable device to show position of individual components of each of the phantoms and juxtaposition of the phantoms relative to the user of the portable user in real time.

In certain embodiments, a software component incorporated into any of the portable devices and the network renders images of genuine counterparts of the corresponding phantoms in the augmented reality projection from a database upon identification of a corresponding computer-vision marker affixed on the corresponding phantom by an imaging module of the portable device and synchronization of the renderings with the received spatial and kinetic information of the corresponding phantom.

In certain embodiments, the imaging module includes a camera and an image processing unit.

In certain embodiments, the spatial and kinetic information, and/or other information of one or more of the phantoms is/are detected by an inertia measuring unit (IMU) embedded in each of the phantoms.

In certain embodiments, the portable device may connect to another augmented reality projection device or incorporate an augmented reality projection module.

In certain embodiments, the software component is configured to communicate with other devices in order to exchange data including motion and position information of one or more of the phantoms or genuine counterpart images thereof to be rendered in a corresponding augmented reality projection from time to time being displayed on among different portable devices or augmented reality projection devices.

In certain embodiments, the software component is also configured to provide feedback to the received motion and position information of one or more phantoms in a form of physically accurate renderings in an augmented reality projection or any other format, where the feedback can also be in a form of physically accurate renderings or any other format, depending on the preference of a respondent.

In certain embodiments, the other format of motion and position information or feedback being displayed in the augmented reality projection can be textual, sensory, audio, visual, and/or olfactory.

This summary is provided to introduce a selection of concepts in a simplified form that are further described below in the Detailed Description. This Summary is not intended to identify key features or essential features of the claimed subject matter, nor is it intended to be used as an aid in determining the scope of the claimed subject matter. Other aspects of the present invention are disclosed as illustrated by the embodiments hereinafter.

### BRIEF DESCRIPTION OF DRAWINGS

The patent or application file contains at least one drawing executed in color. Copies of this patent or patent application publication with color drawing(s) will be provided by the Office upon request and payment of the necessary fee.

The appended drawings, where like reference numerals refer to identical or functionally similar elements, contain figures of certain embodiments to further illustrate and clarify the above and other aspects, advantages and features of the present invention. It will be appreciated that these drawings depict embodiments of the invention and are not intended to limit its scope. The invention will be described and explained with additional specificity and detail through the use of the accompanying drawings in which:

FIG. 1A schematically depicts a design of one of the set of apparatuses (or phantoms) according to certain embodiments of the present invention;

FIG. 1B shows an image of a 3-D printed apparatus according to the design as shown in FIG. 1A;

FIG. 1C shows quaternion measurements of phantoms prepared according to certain embodiments of the present invention which are obtained by a plurality of inertia measuring units (IMUs) tracking motion of the phantoms and cameras (optical) tracking one or more markers thereon;

FIG. 2 schematically depicts a laboratory setting with phantoms simulated in an augmented reality environment according to certain embodiments of the present invention: front perspective view (left panel) and rear perspective view (right panel);

FIG. 3 schematically depicts how motion and position information of one of the apparatuses (phantom) are detected and data derived therefrom are translated into a series of images simulating motion and fluid dynamics of a corresponding laboratory apparatus containing a liquid according to certain embodiments of the present invention; numbers on upper left corners show the time track of snapshots output by an augmented reality device;

FIG. 4 schematically depicts how a change in color of a pH indicator in a virtual liquid (arrowed) be detected real-time during a course of laboratory experiment according to certain embodiments of the present invention; numbers on upper left corners show the time track of snapshots output by an augmented reality device;

FIG. 5 shows a still image of a set of apparatuses being virtually operated by a user output from an augmented reality device according to certain embodiments of the present invention;

FIG. 6A shows an example of interactions between two users of the present platform according to certain embodiments of the present invention;

FIG. 6B shows an example of interactions among multiple users of the present platform according to certain embodiments of the present invention;

FIG. 6C shows another example of interactions among multiple users of the present platform according to certain embodiments of the present invention;

FIG. 6D shows a virtual conical flask with various colors and gradings from a corresponding phantom visualized by signed distance field (SDF) according to certain embodiments of the present invention;

FIG. 7 shows a flow diagram depicting a basic workflow of configuring and using the present platform according to certain embodiments of the present invention.

Skilled artisans will appreciate that elements in the figures are illustrated for simplicity and clarity and have not necessarily been depicted to scale.

### DETAILED DESCRIPTION OF THE INVENTION

It will be apparent to those skilled in the art that modifications, including additions and/or substitutions, may be made without departing from the scope and spirit of the invention. Specific details may be omitted so as not to obscure the invention; however, the disclosure is written to enable one skilled in the art to practice the teachings herein without undue experimentation.

The present disclosure provides a set of replicas of laboratory apparatuses (also referred herein as phantoms) that mimics their corresponding genuine objects in terms of shape, size, weight, and surface features in order to provide a similar haptic and tactile sensation when users of the phantoms hold the same to conduct a virtual laboratory experiment. In certain embodiments, the phantoms are fabricated by methods including 3-D printing via stereolithography and direct light processing, so that surface features of the phantoms fabricated as such can be maximized in terms of their smoothness (or roughness) and other surface details such as some specific curvatures of a particular labware. For example, a customized friction adjusting mechanism can be incorporated into a phantom of stopcock to resemble haptic feeling of using a genuine burette. In addition, the phantoms are incorporated with both wireless monitoring sensors and computer-vision markers to allow real-time detection of their spatial and kinetic information. Again, taking the stopcock phantom as an example, a dual phase resistive position sensor can be incorporated as one of the wireless monitoring sensors for sensing turning of the stopcock to an angular precision of at least 5 arc-seconds.

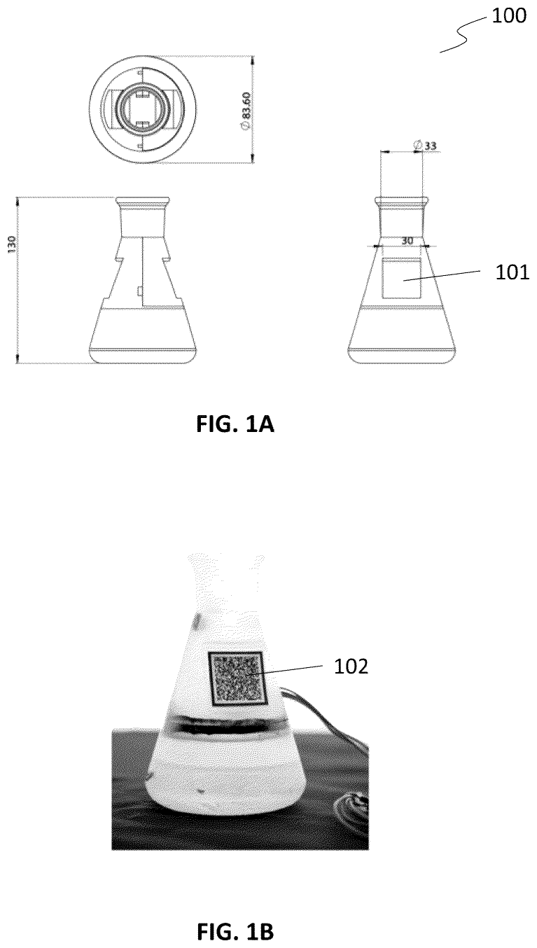

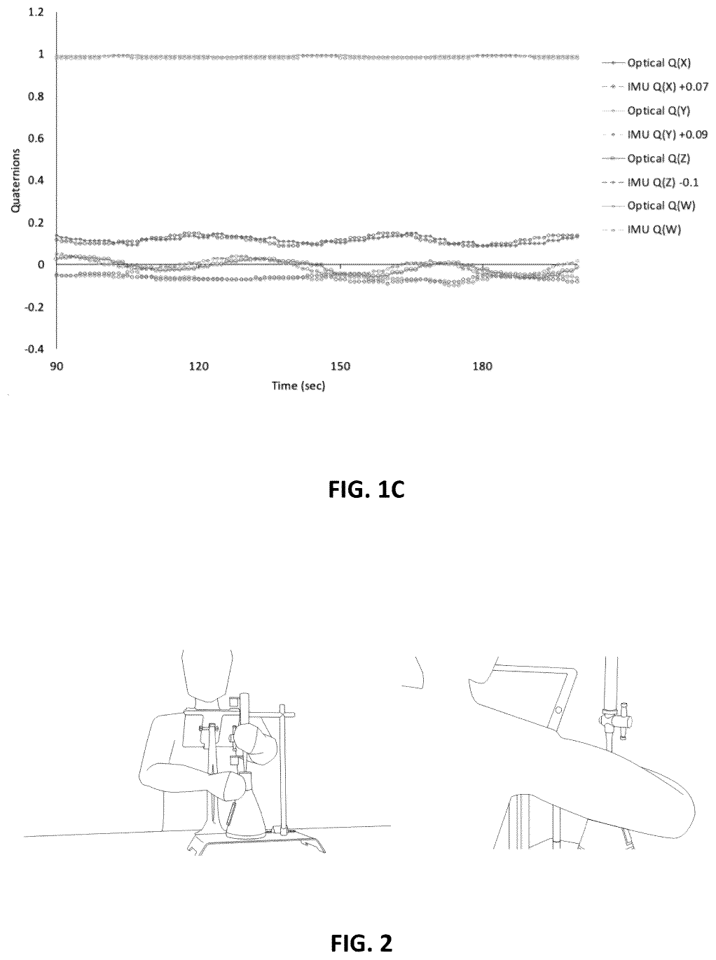

Turning to FIG. 1A, it provides an example engineering design of a phantom conical flask 100 illustrated from top view (top panel), side view (left bottom panel) and a cross-sectional side view (right bottom panel), which includes a chamber 101 for containing a small volume of liquid to mimic haptic and tactile sensation of holding a genuine conical flask with liquid. In this example, an inertia measuring unit (IMU) (not shown in FIG. 1A or 1B) is embedded in the flask body; a computer-vision marker, e.g., OpenCV ArUco Synthetic Marker 102 (as shown in FIG. 1B), is affixed on a surface of the phantom conical flask. The IMU and OpenCV ArUco Synthetic Marker together enable both passive and active tracking of spatial position, linear or angular acceleration and velocity of the corresponding phantom (via IMU data and camera tracking, respectively), while users thereof are provided with a realistic tactile and haptic sensation when swirling liquid in the phantom conical flask. FIG. 1C shows that camera (optical) tracking by capturing and identifying the ArUco marker on the phantom conical flask of its spatial position(s) is precisely synchronized with the corresponding IMU data in terms of quaternions (x, y, z, w) measured by the embedded IMU over time.

Turning to FIG. 2, it provides an example of a laboratory setting with multiple phantoms and a portable device for processing data transmitted from embedded motion- and position-sensors of the phantoms and displaying an output augmented reality (AR) projection on its display screen rendered by a software component in the present platform according to certain embodiments of the present invention. The output of the AR projection on the portable device by the software component in this example are images or animation. The software component is provided to transmit wireless signals from the assembly of motion- and position-sensors embedded in the phantoms, e.g., the IMU described in FIGS. 1A-1C, to a data processing unit of the portable device equipped with a display screen, such as a mobile phone or tablet. The software component is configured to translate motion tracking and sensory data together with position data of the phantom into visual signals or data (images) via physically-based rendering approach and integrate the renderings into the AR projection displayed on the display screen of the portable device, such that location of individual components of each phantom, juxtaposition of multiple phantoms relative to the user of the portable device, and other background objects are shown in real-time on the display screen. In FIG. 2, the software component of the data processing unit can simultaneously track the location of the phantom burette, the position of the burette stopcock and the location of the phantom flask, and render the images of the genuine counterparts of these objects in the AR projection to be shown on the display screen of the tablet or mobile device. Changes of the relative positions of these phantoms and the position of the stopcock are reflected accurately by the images of corresponding objects in the output AR.

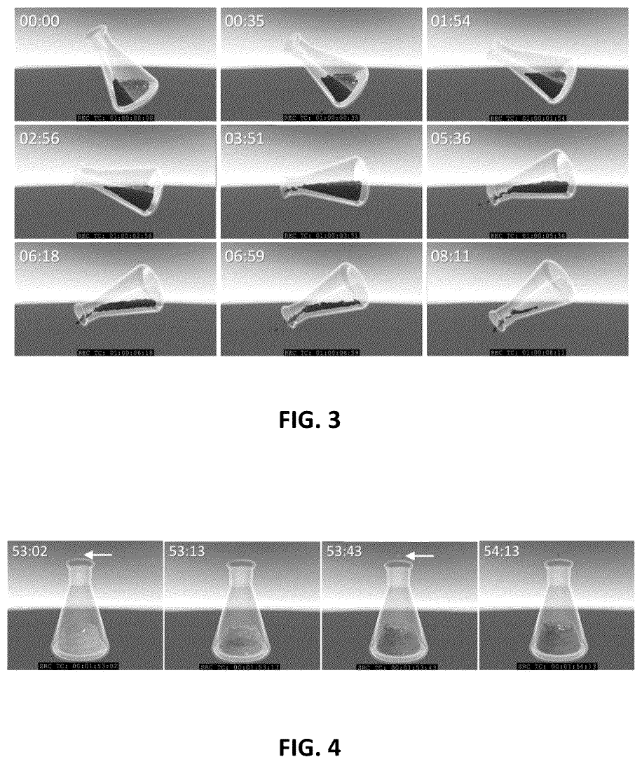

Turning to FIG. 3, it shows other functions of the software component in the present invention. For example, the software component can transform real-time wireless signals detected by the position- and motion-sensors of the phantoms into parameters or conditions of the corresponding laboratory apparatus presented in the output AR. In this example, position and motion data transmitted from the embedded sensors of the phantom conical flask are processed and analysed by the software component to calculate the relative tilting of the phantom at an instant time (T₁) to its vertical position at initial time (Tₒ), and the extent of tilting is recorded and analysed real-time. As soon as the tilting angle of the phantom conical flask exceeds a pre-determined point relative to its initial vertical position at certain time point (T_{N}), the software component will generate a dynamic image of the liquid being poured out of the flask from its opening while a corresponding volume of liquid remained in the liquid chamber of the flask is shown to be reduced in the same dynamic image. The software component continues to process and analyse the motion and position of the conical flask with respect to its tilting angle relative to its initial vertical position. In the same example, continuously increasing the tilting angle of the conical flask relative to its initial vertical position triggers the software component to generate subsequent dynamic image(s) of pouring liquid from the flask opening while reducing the remaining volume of the liquid from the last data time point until the remaining volume of the liquid in the liquid chamber of the phantom conical flask is zero.

FIG. 4 depicts another example of how the software component transforms a rotational, angular motion data of the phantom stopcock (or rotation of corkscrew) of the burette (not shown in FIG. 4) into a corresponding liquid volume. In this example, rotational angle of the phantom stopcock over time relative to its initial orientation is detected by the embedded sensors thereof and transmitted to the data processing unit where the software component will generate a series of dynamic images of dropping liquid from the burette tip into the flask body (first drop of liquid is arrowed in the first frame on the most left panel of FIG. 4) such that a simultaneous rising liquid level in the flask body will be shown in the corresponding dynamic images (from the second to the fourth frames starting from the second most left panel to the most right panel in FIG. 4) until no change in angular motion data relative to the initial position of the phantom stopcock is detected or a pre-determined virtual volume of the liquid from the burette becomes zero. In the same example, the software component is also able to transform the extent of rotational, angular motion of the stopcock into a change in one or more of physical and chemical properties such as pH or temperature between at least two virtual reagents in order to simulate a chemical experiment involving physical and/or chemical reaction of the at least two virtual reagents. As shown in FIG. 4, assuming that the liquids in the phantom burette and the phantom flask are different, and when they are in contact with each other under certain conditions, they will react chemically, as soon as the user change the angular position of the phantom stopcock of the burette, a first reagent from the burette will drop into a second reagent contained in the phantom flask. The software component will translate the degree of change of the angular motion (rotation angle) of the stopcock relative to its initial position into a corresponding virtual volume of the first reagent being dropped into the flask, and according to the pre-determined physical and chemical properties of the two reagents of interest, generate a corresponding visual signal representing the physical and/or chemical property change of the first or second reagent due to the virtual volume of the first reagent dropped into the flask, e.g., a change in color of the second reagent in the flask due to the virtual volume of the first reagent dropped into the flask in the output AR image. The software component is also able to present the change in physical and/or chemical properties of any of the reagents quantitatively and export as a numerical or graphical representation according to the preference of the user. In the example as shown in FIG. 4, the changes in color over time mimics those of a pH indicator in real life. From the first frame (the most left panel) to the fourth frame (the most right panel) shown in FIG. 4, the difference in pH indicator color due to two consecutive drops of liquid (indicated by two separate arrows in the first and third frames, respectively) into the virtual liquid of the phantom flask in the corresponding output AR images is given by a real-time pH computation algorithm of the software component based on the degree of change of the rotation angle of the corkscrew by the user.

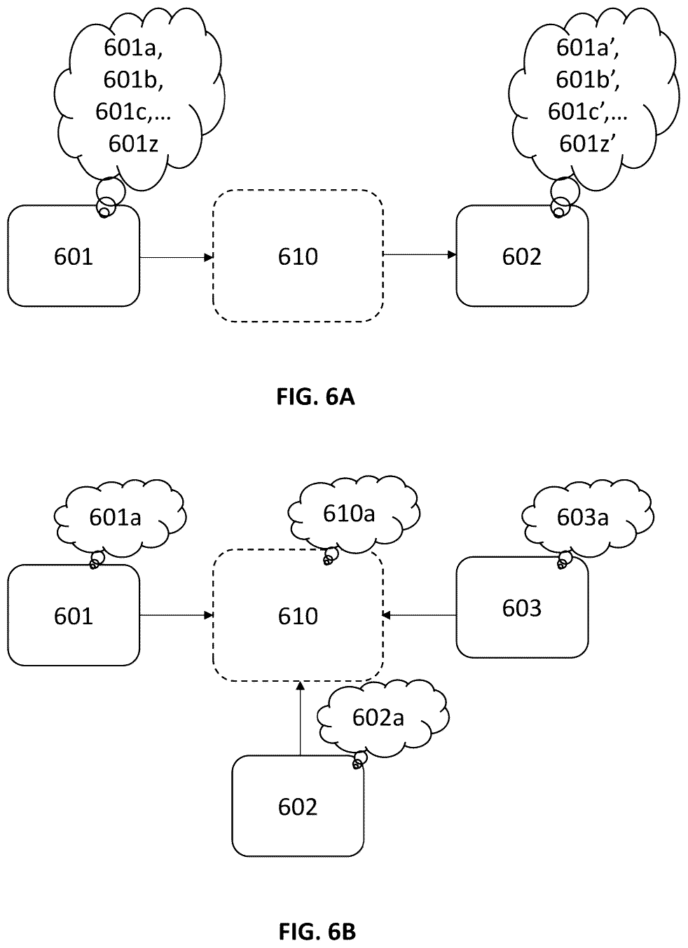

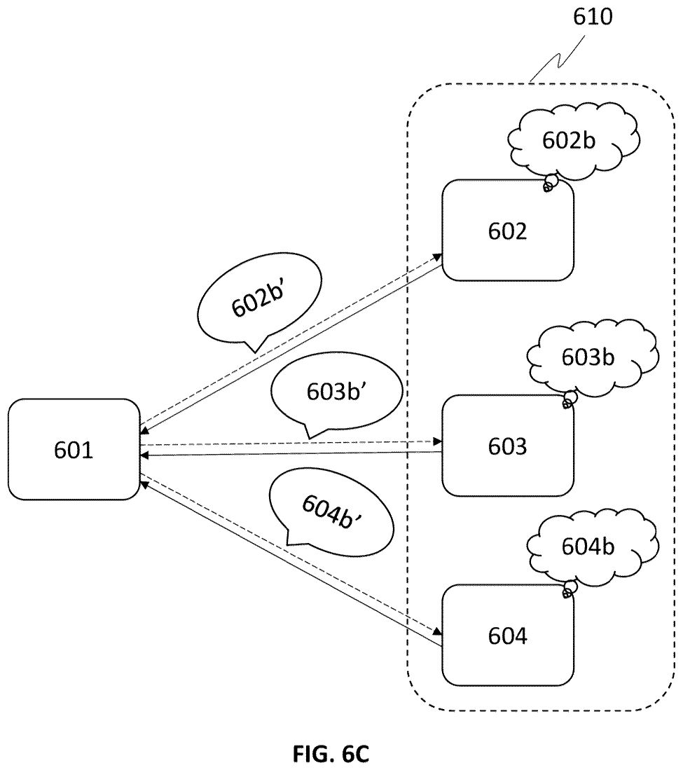

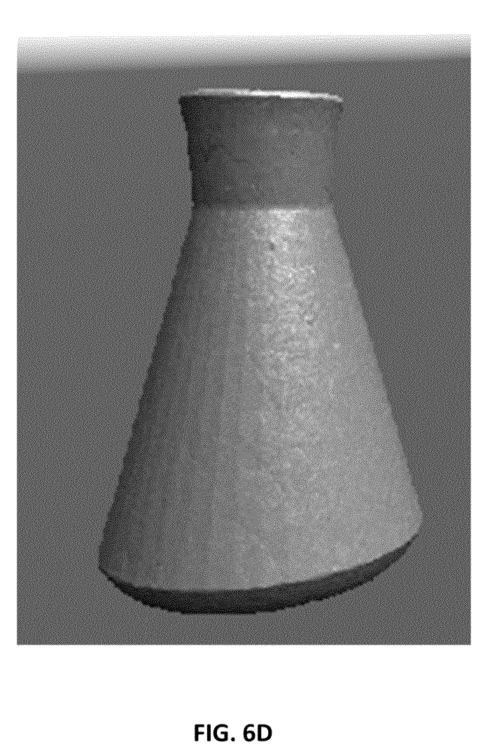

In certain embodiments of the present invention, the software component in the present invention is used to calculate virtual volume of liquid from the AR outputs of the corresponding phantoms by calculating particle counts within signed distance field (SDF) boundaries, where each particle is a representation of a quantum of the liquid (e.g., 0.1 ml). A visualization of virtual conical flask from a corresponding phantom conical flask by SDF is shown in FIG. 6D. The reaction between the liquid from the burette, called the titrant, and the liquid in the conical flask, called the analyte, indicated e.g. by a change in color, is determined by the ratio of the virtual liquid from the phantom burette to the virtual liquid in the phantom conical flask, and the dispersion value of the mixed fluid (i.e., how well the two fluids are mixed). In the case of translating a motion around stopcock (or corkscrew) into a color change in a fluid of the receiving flask, a series of the rotation (angular) motions of the stopcock (or corkscrew) of the phantom burette are mapped by a linear interpolation (LERP) with customizable values to a fluid emitter.

At the beginning of a typical laboratory session, the user will be instructed either by another user or by a corresponding virtual instructor with certain level of artificial intelligence to pour an arbitrary amount of titrant from a phantom beaker to the phantom burette. The volume of the titrant delivered to the phantom burette is calculated according to an extent of the tilting of the phantom beaker during the pouring action, by the particle count within the SDF boundaries where each particle is a representation of a quantum of the fluid (e.g., 0.1 ml). This volume (V1) will be indicated by the position of the meniscus of the liquid in the phantom burette. During titration, the titrant will be delivered from the phantom burette to the phantom conical flask by turning the phantom burette's stopcock. The rotation (angular) motion of the stopcock is mapped to the fluid emitter with a linear interpolation (LERP) having customizable values, which measures an effective diameter of a liquid passage channel formed by the opening of the stopcock and the duration in which the liquid passage channel is opened. This information is converted into a liquid volume (V2) using data collected by empirical experiments. During the titration experiment, the value of V2 will increase. The volume of titrant remained in the phantom burette is calculated in real-time by subtracting V1 by V2, until V1-V2=0 when the phantom burette will look empty.

Before the experiment, the user, e.g., a student, will be instructed to deliver a fixed volume (e.g., 25 ml or 50 ml, as V3) of an analyte from a phantom beaker to a phantom conical flask, using a phantom pipette. During the titration experiment, the volume of liquid in the phantom conical flask is calculated, in real-time, by adding V2 to V3. The pH of the mixture in the phantom conical flask is thereby calculated, in real-time, by the concentration of each of reactants in the titrant and the analyte with reference to corresponding published dissociation constants of the reactants. In one example, the titrant is a solution of hydrochloric acid of known concentration and the analyte is a solution of sodium carbonate of a certain concentration that is unknown to the student. When the titrant is added into the analyte, the following reaction will occur:

HCl+Na₂CO₃→H₂O+CO₂+NaCl (1)

The pH (i.e., the concentration of hydrogen ions) of the mixture at any point during the titration experiment (at any concentration of the titrant) is calculated from the dissociation constants of the two displacement reactions, the pH of CO3(2−) and HCO3(−), as well as the concentration of excess HCl, if any):

CO²⁻+H⁺→HCO₃⁻+H₂O (dissociation constant=4.0×10⁻⁶ M) (2)

HCO₃⁻+H⁺→CO₂+H₂O (dissociation constant=2.5×10⁻¹¹ M) (3)

The concentration of hydrogen ions at any point during the titration experiment is then converted into color of the mixture in the phantom conical flask based on the published absorption spectrum of the pH indicator at a given pH. In one example, the pH indicator is phenolphthalein. The student will be instructed to use a phantom dropper to deliver a small volume of a phenolphthalein solution of known concentration into the phantom conical flask which contains the analyte. The resulting phenolphthalein concentration is calculated in real-time according to V2+V3. The color of the mixture in the phantom conical flask is generated from an effective concentration of phenolphthalein at any point of the titration experiment and the absorption spectrum of phenolphthalein at the hydrogen ion concentration at this point of the experiment as calculated from equations (2) and (3). A realistic rendering of solution mixing and color change in the phantom conical flask is made possible by calculating the dispersion value of the mixed fluid.

In any of the foregoing described examples, the software component will timestamp each of the output AR images corresponding to the time of detection of the relative motion and/or position data of the phantom by the corresponding motion- and position-sensors.

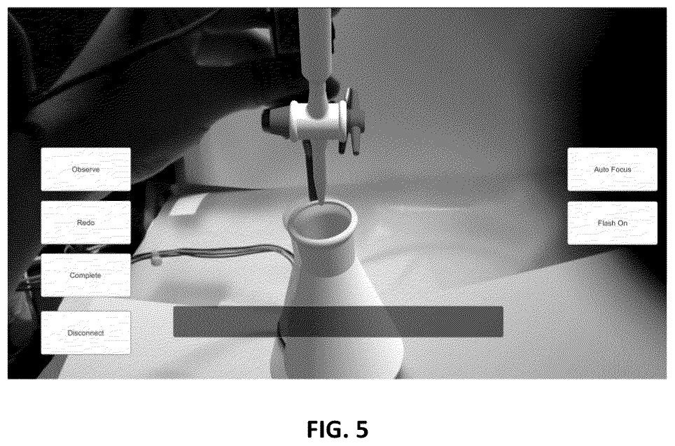

FIG. 5 shows an image of a user interface with an AR image output by the software component and displayed on a display screen of the portable device, e.g., tablet or mobile device, according to certain embodiments of the present invention, in which virtual images of burette, conical flask, background objects together with the user's hand image are integrated into the output AR image on the display screen of the portable device with two columns of instruction menu. In this example, the instruction menu on the user interface allows user to select different contents to be displayed on the display screen of the portable device under an AR environment, where the contents include textual, audio, or video, or multimedia content relating to laboratory experiment. For example, a student is shown with background information and procedures of how a titration experiment is carried out on the mobile device, followed by a short quiz that will ensure the student to have understood the theory of the experiment. Then, the student will be instructed to set up the apparatuses for titration by using the phantoms. Markers on the phantoms will be detected and identified prior to commencement of the experiment to ensure that the setup is correct. The student can practice acid-base titration by using the phantom of a pipette to deliver a precise volume of the analyte into a phantom conical flask. While the physical objects are dry, the student can visualize this action, with liquid, on the AR screen (FIG. 5). Similarly, the student can proceed with the rest of the titration procedures by using a phantom burette. A data processing unit will sense his/her hand movement in terms of motion data transmitted by wireless sensor(s) and show dynamic images of the delivery of liquids in volumes that correspond to the movement of the phantom stopcock. The color of an indicator in the flask will also be computed according to the volume of the chemicals in the mixture and the speed at which the student swirls the flask. Since all the phantoms are empty and unbreakable, the student can learn and practice the technique of titration (precise handling of liquids in a chemistry lab) remotely from his/her home using an AR device without any safety issues.

The software component also allows connection of data from multiple mobile devices into a network, so that users can see one another's AR images, and record data from one another's phantoms. In one example, the AR images of a titration experiment (601a, 601b, 601c . . . , 601z) set up by one individual 601, e.g., an instructor, can be shown in the same virtual space 610 as another individual 602, e.g., a pupil, so that the pupil can follow the step-by-step demonstration from the instructor (601a′, 601b′, 601c′ . . . , 601z′) (FIG. 6A). In another example, multiple individuals (601, 602, 603), each equipped with one or more of the phantoms (601a, 602a, 603a) required for a large experiment, can virtually assemble an equipment 610a and perform the experiment in the same virtual space 610 (FIG. 6B). In a third example, data (602b, 603b, 604b) from the mobile devices of multiple pupils (602, 603, 604) can be transmitted to the instructor 601, who can monitor the performance of each pupil in real time, identify errors or respond to questions almost spontaneously (602b′, 603b′, 604b′) (FIG. 6C).

In certain embodiments where multiple participants log in the same session, remote procedure call (RPC) from Netcode for GameObjects, a networking library, is utilized in the network to communicate among multiple users of the present platform. At a high level, when calling an RPC client side, a software development kit (SDK) will take a note of an object, component, method and any parameters for that RPC and send that information over the network. A server will receive that information, find the specified object, find the specified method and call it on the specified object with the received parameters on all available clients. It could either be done in a) client-hosted multi-user session where one of the users, presumably the teacher, can host a session for student to join; or b) a dedicated server hosted on cloud/on-location. Alternatively, other web service approaches can also be used in the context of setting up multi-user communication and synchronization of a relatively large amount of data, by calling to a resource, for example.

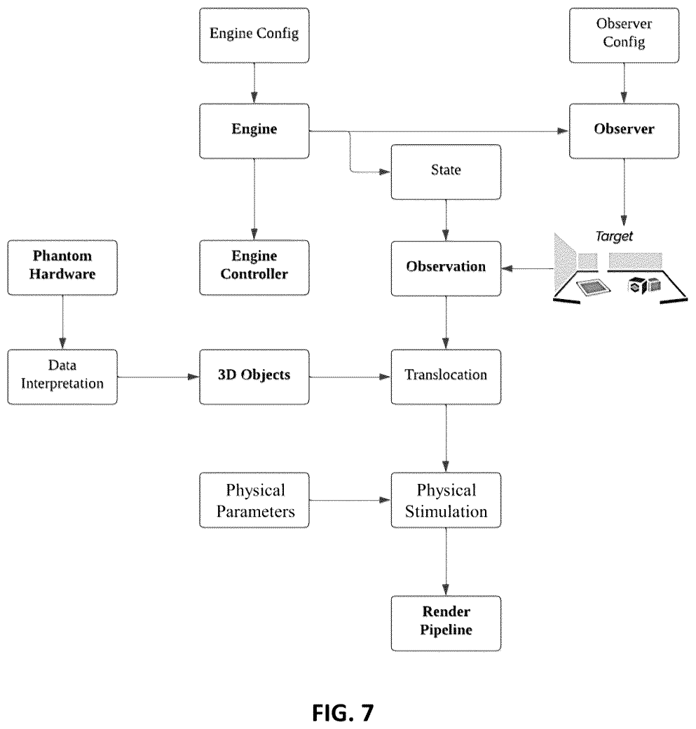

FIG. 7 depicts an overall idea of how the present platform is configured and used to deliver an AR projection in multiple devices: from configuring the sensing mechanisms to determine motion, kinetic and physical state of one or more target objects, together with other information of the targeted objects provided by one or more users (observers) such as identity of the objects, to conclude an observation; from the measurements by the sensors of the phantoms, the data as measured will be translated by the software component of the platform into one or more corresponding 3D objects and in combination with the observation to result in translocation of the corresponding 3D objects in the AR projection; with the aid of certain published physical parameters fed into the platform, the translocated 3D objects will be displayed in the same virtual space shared by more than one user of the platform.

Although the invention has been described in terms of certain embodiments, other embodiments apparent to those of ordinary skill in the art are also within the scope of this invention. Accordingly, the scope of the invention is intended to be defined only by the claims which follow.

### Industrial Applicability

The present invention is applicable to provide remote online learning of laboratory techniques in different subjects, particularly STEM subjects, by providing learners with physical replicas of lab apparatuses. By handling these replicas, together with AR experience provided by the present platform, the student will learn the dexterous skill and eye-hand coordination that cannot be replicated by other conventional remote learning platforms.

By the present invention, it is possible to collaborate on group experiments, in which students can manipulate the phantoms at their own homes, while visualising the instructor and other students in the same virtual spaces. In particular, instructors can demonstrate to the class how to handle the phantoms, and then remotely check how accurately the students follow the instructions in real-time. In long term, big data on learning performance can be collected, allowing the effectiveness of new pedagogies to be systematically quantified. The present invention also allows students to carry out lab techniques repeatedly without restriction to location and time, and substantially no implications on cost and safety, unlike traditional face-to-face lab classes where the number of times a student can attempt an experiment is limited by the availability of the lab and the student's class schedule. Thus, the present invention enables students to “learn by mistakes”, at wherever and whenever they wish or are available, while still under the guidance of their instructors

What is claimed is:

1. An interactive learning platform for users thereof to learn and practice skills of handling genuine objects used in real-life scientific experiments from experiencing in a virtual space, the platform comprising:
a set of phantoms ornamentally and proportionally replicating the genuine objects;
one or more portable devices configured to display an augmented reality projection of the virtual space incorporated with the set of phantoms being transformed into dynamic images of the corresponding genuine objects;
a network for each of the users to share and synchronize motion, position, image and other data of the corresponding phantoms with another user in the same virtual space;
each of the phantoms being embedded with an assembly of motion- and position-sensors and affixed on a surface thereof with at least one computer-vision marker for accurately tracking spatial and kinetic information of the phantoms,
the network being configured to implement a computer-implementable program for transforming the motion, position, image and other data of the phantoms shared by one of the users of the platform into the dynamic images and synchronized the dynamic images with those transformed from motion, position, image and other data of the phantoms shared by other users within the augmented reality projection of the virtual space.

2. The platform of claim 1, wherein the assembly of motion- and position-sensors comprises one or more wireless monitoring sensors.

3. The platform of claim 2, wherein the one or more wireless monitoring sensors comprise an inertia measuring unit (IMU) and a dual phase resistive position sensor

4. The platform of claim 1, wherein the at least one computer-vision marker comprises an OpenCV ArUco synthetic marker.

5. The platform of claim 1, wherein the at least one computer-vision marker is affixed on the surface of each of the phantoms in a way to be visualized and captured by an imaging module.

6. The platform of claim 1, wherein the assembly of motion- and position-sensors is configured to passively track spatial position, linear or angular acceleration, and linear or angular velocity of the corresponding phantom.

7. The platform of claim 1, wherein the portable devices comprise a simulation module for realizing augmented reality and an imaging module for capturing the at least one computer-vision marker affixed on the surface of the corresponding phantom and determining identity thereof.

8. The platform of claim 7, wherein a timestamp is provided for each of the images captured by the imaging module in order to facilitate sequencing of the captured images and synchronization with the corresponding spatial and kinetic information obtained by the assembly of motion- and position-sensors.

9. The platform of claim 1, wherein the one or more phantoms are fabricated by 3-D printing.

10. A method for using the platform of claim 1 to deliver an interactive laboratory experiment lecture real-time in simulated environments, the method comprising:
one or more users of the platform connecting one or more of his or her portable devices remotely to a network at where the laboratory experiment lecture is to be delivered;
a first user or any subsequent users to the first user creating or selecting a virtual laboratory setting and corresponding protocols for the laboratory experiment lecture to be delivered via a user interface of a program implementable on his or her corresponding portable device;
displaying the virtual laboratory setting with or without any virtual laboratory apparatuses on a display panel of one or more of the portable devices, upon the corresponding users' preference to participate as a learner or instructor of the lecture;
each of the first and the subsequent users sending a request for spatial, kinetic and/or other information of another user's phantom or transmitting spatial, kinetic, and/or other information of his or her phantom, or both simultaneously, from his or her portable device to the network;
receiving the spatial, kinetic and/or other information of another user's phantom simultaneously from the network and transforming corresponding spatial position and motion data into a series of dynamic images to be integrated into the virtual laboratory setting and displayed as an augmented reality images on the display screen of the corresponding portable device;
any of the first and subsequent users of the platform continuously sending, transmitting, and receiving the spatial, kinetic and/or other information of another user's phantoms via the network and the corresponding augmented reality images being synchronized with the augmented reality images of his or her phantom in the same virtual laboratory setting to be displayed on the display screen of the corresponding portable device over a course of the laboratory experiment lecture until a command or instruction to pause, exit or cease the lecture by any of the users according to his or her preference.

11. The method of claim 10, wherein said transforming the spatial and kinetic information into the dynamic images to be integrated into the virtual laboratory setting and displayed as augmented reality images is based on a physically-based rendering approach as physically accurate renderings.

12. The method of claim 11, wherein the physically accurate renderings are incorporated into augmented reality projection to be displayed on the display screen of the corresponding portable device to show position of individual components of each of the phantoms and juxtaposition of the phantoms relative to the user of the portable user in real time.

13. The method of claim 11, wherein a software component incorporated into any of the portable devices and the network renders images of genuine counterparts of the corresponding phantoms in the augmented reality projection from a database upon identification of a corresponding computer-vision marker affixed on the corresponding phantom by an imaging module of the portable device and synchronization of the renderings with the received spatial and kinetic information of the corresponding phantom.

14. The method of claim 13, wherein the imaging module comprises a camera and an image processing unit.

15. The method of claim 10, wherein the spatial and kinetic information, and/or other information of one or more of the phantoms is/are detected by an inertia measuring unit embedded in each of the phantoms.

16. The method of claim 10, wherein the portable device connects to another augmented reality projection device or incorporates an augmented reality projection module.

17. The method of claim 13, wherein the software component is configured to communicate with other devices in order to exchange data including motion and position information of one or more of the phantoms or genuine counterpart images thereof to be rendered in a corresponding augmented reality projection from time to time being displayed among different portable devices or augmented reality projection devices.

18. The method of claim 13, wherein the software component is configured to provide feedback to the received motion and position information of one or more phantoms in a form of physically accurate renderings in an augmented reality projection or any other format, subject to preference of a respondent.

19. The method of claim 18, wherein the other format of motion and position information or feedback being displayed in the augmented reality projection is one or more selected from textual, sensory, audio, visual, and/or olfactory.
